(19) United States
(12) Patent Application Publication
(10) Pub. No.: US 2015/0199323 A1
(43) Pub. Date: Jul. 16, 2015

(54) METHOD AND SYSTEM FOR POSTING COMMENTS ON WEB PAGES

(71) Applicants: Jesse Kelly SULTANIK, Tel Aviv (IL); Batell Valentine Blaish, Tel Aviv (IL); Nir Naor, Herzlia (IL); Nitzan Gelbard, Beit-Herut (IL); David Elentok, Netanya (IL); Avi Katz, Hofit (IL)

(72) Inventors: Jesse Kelly SULTANIK, Tel Aviv (IL); Batell Valentine Blaish, Tel Aviv (IL); Nir Naor, Herzlia (IL); Nitzan Gelbard, Beit-Herut (IL); David Elentok, Netanya (IL); Avi Katz, Hofit (IL)

(73) Assignee: Jesse Kelly Sultanik, Tel Aviv (IL)

(21) Appl. No.: 14/594,675

(22) Filed: Jan. 12, 2015

Related U.S. Application Data
(60) Provisional application No. 61/925,711, filed on Jan. 10, 2014.

(51) Int. Cl. G06F 17/24; H04L 29/08

(52) U.S. Cl. CPC G06F 17/241; H04L 67/02

(57) ABSTRACT

Methods and systems that allow users to post comments to web pages and web sites, independent of the web pages and web sites themselves. The posting of comments can be on almost every web page and web site on the World Wide Web (WWW), regardless of the entity hosting controlling or administering the web page or web site, and regardless of the web page or web site having its own comment area.

### CROSS-REFERENCES TO RELATED APPLICATIONS

This application is related to and claims priority from commonly owner U.S. Provisional Patent Application Ser. No. 61/925,711, entitled: Method and System for Posting Comments on Web Pages, filed on Jan. 10, 2014, the disclosure of which is incorporated by reference in its entirety herein.

### TECHNICAL FIELD

The present invention relates to methods and systems for administering comments made by users, associated with web sites and web pages.

### BACKGROUND

Numerous web sites and web pages provide areas on the web site or web page where users, who have directed their browsing application to these web sites or web pages, can post comments. These comments remain on the pages and are viewable by other users, who have directed their browsing application to these web sites or web pages. The comments are controlled by the operator of the web site or web page. As a result of this control, comments may be taken off the web site or web page at any time, and in some cases, the comments may never be posted in the comment areas of the web sites or web pages, due to censorship by the operator of the web site or web page.

Additionally, the aforementioned comments can only be posted if the web page has a comment section. Moreover, users who want to make comments must have an account with the web site or the entity, for example, a third party, administering the comment section for the web site. This deters many users, who only want to comment once, and view having to get an account to make a comment as a burden.

### SUMMARY OF THE DISCLOSED SUBJECT MATTER

The present invention includes embodiments that are directed to methods and systems that allow users to post comments to web pages, and also web sites, independent of the web pages and web sites themselves. As a result, users do not have to see if a comment area of a web page, provided by the web page host or other third party administrator of the comment section of that web page, is even available and/or accessible, so they can post comments. The present invention includes embodiments that allow for the posting of comments on almost every web page and web site on the World Wide Web (WWW), regardless of the entity hosting, controlling or administering the web page or web site, and regardless of the web page or web site having its own comment area.

Some embodiments of the present invention are directed to a system and method for the generation and administration of web documents or electronic documents, collectively known as “web documents,” with “web documents” and “electronic documents” used interchangeably herein, which is programmed to overlie a web page or web site on which users can post (make or input) and interact with existing comments—the comments coming in the form of text, graphics and the like, over a network such as the Internet. The web document or electronic document, which makes the posting of and interaction with comments possible, is generated and administered by the system of some embodiments of the present invention to be completely independent of the web site or web page which it overlies, and the entity hosting the web site or web page which the electronic document overlies, or the web site or web page itself, does not have any control over the web document or electronic document on which the users post their own comments and interact with the comments of others.

Some embodiments of the present invention are also directed to a downloadable application for providing users the ability to input displayable media, including text and the like, and transmit this displayable media over a network, such as the Internet, to a web document or electronic document, which overlies a web site or web page. The displayable media is then posted on this web document or electronic document, for example, as a comment.

The present invention includes embodiments which allow users, who, for example, have downloaded an application in accordance with embodiments of the present invention, the application which allows for the users to post comments at one or more certain locations on an overlying web document (the overlying web document, in accordance with embodiments of the present invention). The one or more locations on the overlying web document correspond with the desired one or more locations on the underlying and actual web site or web page, where the users want their posted comments to appear. For example, the desired one or more locations may be content of interest, such as an article, picture, advertisement, phrase, tab, banner or the like on the underlying actual web page or web site. This posting at specific locations may be indicative of topics of current interests, trends, and the like.

Some embodiments are directed to a method for posting displayable media, for example, comments, formed of text, graphics and the like, on web pages over a network, such as a communications network, including the Internet. The method comprises: receiving a request from a first user to render an electronic document over at least a portion of a target web page to which the browsing application of a computer of the first user is directed; automatically responding to the received request including rendering an electronic document to the target web page over a network; receiving displayable media input from the first user whose browsing application is directed to the target web page, the computer of the first user being associated with the electronic document; and, placing the displayable media input into the electronic document, the electronic document with the displayable media for overlying at least a portion of the target web page. The displayable media, for example, includes text, which defines forms at least a portion of a comment.

The method additionally comprises rendering the electronic document including the displayable media in a viewable format to the browsing application of a computer of a second user over the target web page, when the browsing application of the computer of the second user is directed to the target web page and the computer of the second user is associated with the electronic document. Additionally, the electronic document is independent of the target web page.

Some embodiments of the present invention are directed to a system for facilitating the posting of displayable media on web pages over a network. The system comprises a processor; and, a storage media in communication with the processor for storing instructions executable by the processor. The instructions comprise: receiving a request from a user to render an electronic document over at least a portion of a target web page to which the browsing application of a computer of the user is directed; automatically responding to the received request including rendering an electronic document to the target web page over a network; receiving displayable media input from the user whose browsing application is directed to the target web page, the computer of the user being associated with the electronic document; and, placing the displayable media input into the electronic document, the electronic document with the displayable media for overlying the target web page. Additionally, the electronic document is independent of the target web page.

Some embodiments of the present invention are directed to computer usable non-transitory storage media, having a computer program embodied thereon for causing a suitably programmed system to facilitate the posting of displayable media on web pages over a network, by performing the following steps when such program is executed on the system. The steps comprise: receiving a request from a first user to render an electronic document over at least a portion of a target web page to which the browsing application of a computer of the first user is directed; automatically responding to the received request including rendering an electronic document to the target web page over a network; receiving displayable media input from the first user whose browsing application is directed to the target web page, the computer of the first user being associated with the electronic document; and, placing the displayable media input into the electronic document, the electronic document with the displayable media for overlying at least a portion of the target web page.

The computer usable non-transitory storage medium is such that the displayable media includes text defining a comment and the electronic document is independent of the target web page. Additionally, the aforementioned steps may also include the step of rendering the electronic document including the displayable media in a viewable format to the browsing application of a computer of a second user over the target web page, when the browsing application of the computer of the second user is directed to the target web page and the computer of the second user is associated with the electronic document.

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, or a touch, swipe, or the like on a touch screen, on a location on a computer screen display, which is activatable, for example, an activatable icon, that causes an action of the various software and or hardware, including that for executing applications and supporting the computer screen display.

In a standard computer pointing device, known as a mouse, the apparatus has a left button, which is typically the primary or default button, and a right button, through which activations can be made by pressing the requisite button. Pressing the left button results in a “left click,” while pressing the right button results in a “right click” on the right mechanism. A “left click” includes any “click”, “clicks”, “clicks on”, “click on” that results in a primary action taken by the software and or hardware components of the user computer. A “right click” includes any “click”, “clicks”, “click on”, “clicks on” that results in a secondary action, such as adding or modifying the action options that the user can cause the software and or hardware components of the computer to take. These settings on the pointing device are typically the default settings, but may be switched, depending on the user. In this document, the default settings are used and described.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page that is accessible on Networks including the Internet.

A server is typically a remote computer or remote computer system, or computer program therein, that is accessible over a communications medium, such as a communications network including the Internet, that provides services to other computer programs (and their users), in the same or other computers.

An “application” or “App”, includes executable software, and optionally, any graphical user interfaces (GUI), through which certain functionality may be implemented.

A “client” is an application, computer program, or the like, that runs on a computer, workstation or the like and relies on a server to perform some of its operations or functionality.

“n” and “n^{th}” in the description below and the drawing figures represents the last member of a series or sequence of servers, databases, caches, components, listings, links, data files, etc.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, PDA, or cell phone).

A “comment” includes expressions, statements, sentences, sentence fragments, symbols, and any combinations thereof, in any language, presented as text, graphics, links, audio, video, and any other form of electronic textual media, or other displayable media, including any combinations thereof.

HTTP (Hypertext Transfer Protocol) is an application protocol for distributed, collaborative, hypermedia information systems. Hypertext is structured text that uses logical links (hyperlinks) between nodes containing text. HTTP is the protocol to exchange or transfer hypertext.

HTML (Hypertext Markup Language) is the set of markup symbols or codes inserted in a file intended for display on a World Wide Web browser page.

A GET request is an HTTP command used to request a file, or series of files, from a Web server. GET requests are, for example, implemented in HTML files (Web pages) for making database queries that do not involve any updating at the server side. In this document, GET requests are generic to all types of GET requests, while BUBBLE GET requests, COMMENT GET requests, and NOTIFICATION GET requests, are specific types of GET requests and are indicated as such.

A POST request is an HTTP command requesting that a web server accept the data enclosed in the request message's body for storage. POST requests are used, for example, when uploading a file or submitting a completed web form.

An AJAX (Asynchronous JavaScript and XML) Request is an HTTP request made by (browser-resident) Javascript that uses XML (Extensible Markup Language) to encode the request data and/or response data.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 1-1 is a diagram of a screen shot showing an exploded view of a web document, which is generated by the system in accordance with embodiments of the invention, overlying a web page;

FIG. 2A and 2B are diagrams of the architecture of the system in accordance with embodiments of the disclosed subject matter;

FIGS. 3A-3D are flow diagrams of a process in accordance with embodiments of the disclosed subject matter;

FIG. 4 is a flow diagram of a process in accordance with embodiments of the disclosed subject matter; and,

FIGS. 5A-1-5S are screen shots or screen diagrams that appear on the monitor of the computer of the user in accordance with embodiments of the disclosed subject matter, during the processes represented by FIGS. 3A-3D, and 4.

### DETAILED DESCRIPTION OF THE DRAWINGS

Throughout this document, numerous textual and graphical references are made to trademarks. These trademarks are the property of their respective owners, and are referenced only for explanation purposes herein.

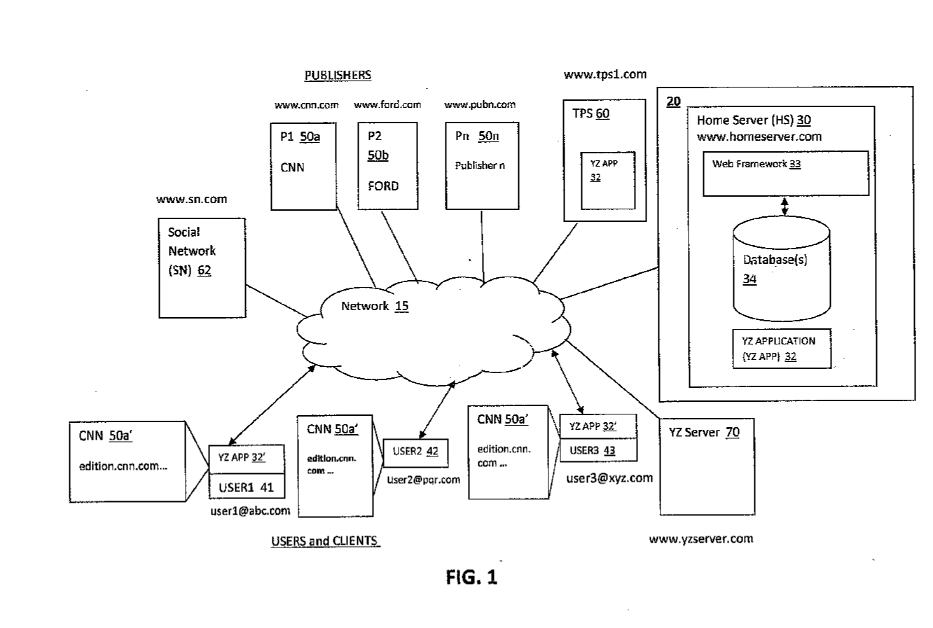

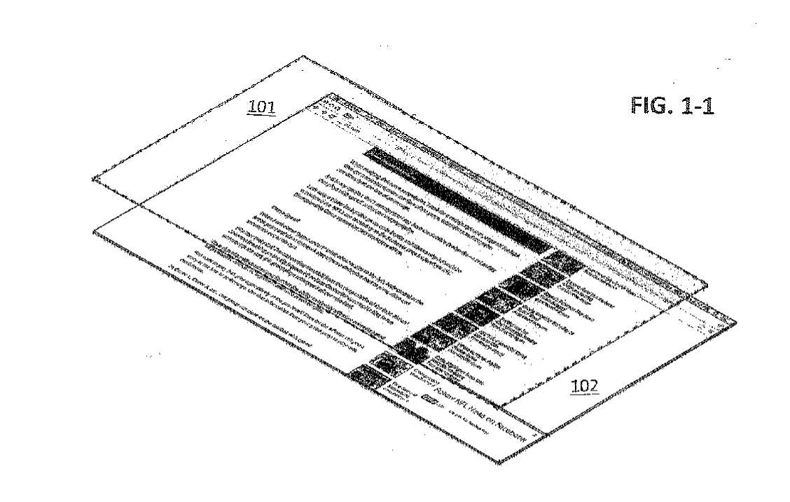

Reference is now made to FIG. 1, which shows an exemplary operating environment, including a network 15, to which is linked a non-limiting exemplary system 20, in accordance with some embodiments of the present invention. The system 20 is formed of various servers and server components, computers, computer devices and the like, storage media, processors, and the like. The network 15 is, for example, a communications network, such as a Local Area Network (LAN), or a Wide Area Network (WAN), including public networks such as the Internet. As shown in FIG. 1, the network 15 is the Internet.

The system 20 links to the network 15. The system 20 is formed of components including a home server (HS) 30, also known as a main server. The system 20, for example, via the home server 30, includes hardware and software, and combinations thereof, as detailed further below, which generates and administers web documents, also known as electronic documents (collectively known as “web documents,” with “web documents” and “electronic documents” used interchangeably herein). These web documents are programmed to overlie web sites and web pages (for example, as shown in FIG. 1-1, the web document 101 is designed to overlie the web page 102), or portions of the web sites and web pages. The web documents (electronic documents) serve to support comments posted (made or inputted) by users, e.g., user1 41 and user3 43 (representative of multitudes of users of the system 20 (the system 20 including the home server 30 and system 30′ thereof), via the network 15, who have downloaded the YZ APP 32 onto their computers). The comments are, for example, in the form of text, graphics and the like, and received by the web documents, over the network 15, such as the Internet. The web documents are generated and administered by the system 20, e.g., including the system 30′ of the home server 30, to be completely independent of the web site or web page which it overlies. Additionally, the entity hosting the web site or web page, which the web document overlies, for example, CNN.com 50a for the web page hosted by CNN.com 50a′ on the computer of user1 41, does not have any control over the overlying web documents, presented by the home server 30 of the system 20, on which users post their comments and interact with the comments of other users.

The home server 30 includes a client application (APP) 32, for example, known as the YZ APP (hereinafter also referred to with the element number 32). The YZ APP 32 is downloadable by user computers, for example, represented by the computers of the users 41-43, who are in turn, representative of all users with computers linked to the system 20 via the network 15, as detailed below.

The users 41, 42 and 43 are representative of multitudes of users whose computers are linked to the network 15, either directly or indirectly, and who can access the system 20, and the home server 30 and system 30′ thereof, via the network 15, and download the application 32 (the YZ APP) and with the application 32 downloaded on their computers, post comments on web sites and web pages, as disclosed herein. Throughout this document the computers of the users 41-43 are also referred to by these element numbers, and, for example, are referred to as user computers 41-43, representing the computers of user1 41, user2 42 and user3 43, respectively. These computers 41-43 are representative of multiple user computers (of multiple users) linked to the network 15 and accessing the system 20. The user computers 41-43 are, for example, personal computers with, for examples, Windows® or Mac® operating systems and processors such as Intel Pentium® processors, and the like, capable of running multiple applications, and may also include tablet (e.g., iPad® from Apple of Cupertino, Calif.) and laptop computers, as well as mobile devices, such as smart phones (e.g., iPhone® from Apple of Cupertino, Calif.), iPods® and the like. The user computers 41, 42, 43, are linked to the network 15, either directly or indirectly. These computers include monitors or display screens on which the user can view different types of media.

The home server (HS) 30 is of an architecture that includes one or more components, modules and the like, for providing numerous additional server functions and operations, for running the processes associated with the application 32 upon its being downloaded by a user computer 41-43. The home server 30 also includes a web framework 33 and a database 34, also referred to as a main database, which includes tables 36. The home server 30 links to the network 15, either through the system 20, or directly. The home server (HS) 30 may be associated with additional storage, caches and databases, both internal and external thereto. For explanation purposes, the home server (HS) 30 may have a uniform resource locator (URL) of, for example, www.homeserver.com. While a single home server (HS) 30 is shown, the home server (HS) 30 may be formed of multiple servers and/or components.

The client application 32, e.g., the YZ APP (which will also be referenced as 32 herein), when deployed on a computer of a user, for example, user1 41 and user3 43 (users1 and 3 representative of multiple users of the system 20 who have downloaded the YZ APP 32), following a download by a user (the application 32 at the user computer represented by element 32′), maps back to the home server 30 in order to perform its stated functions and data retrieval. The YZ APP 32 also includes, for example, a CSS (Cascading Style Sheet) Selector, which allows the client to distinguish between the different HTML elements found within the body of a web page. The user computers 41, 42, 43 are suitably programmed for supporting the client application, e.g., the YZ APP 32′ (the YZ APP 32′ being known by this element number 32′ as it has been downloaded to the user or client computers 41, 43 in FIG. 1).

The client application 32 allows users, represented by user1 41 and user3 43, to make and view one or more comments through one or more comment boxes (detailed herein below) at user-selected locations inside the preset layout of the content of web page(s), which the comment boxes, and their corresponding comment icons, overlie and refer to. The comments are associated with the content of the web page of any publisher P1-Pn 50a-50n, or other web page. The comments, stored in comment icons and their corresponding comment boxes, are located based on the location where the user-selected content appears on the underlying web page. The application 32′ allows for the transmission of these comments to the home server 30, for example, over the network 15. The home server 30 receives and stores these comments, and displays these comments as a web document overlying the publisher P1-Pn 50a-50n web page or third party web page, from a third party server (TPS), completely separate from, and independent of, and outside the control of, the publisher or third party and their web site, web page and/or server(s). The comments stored on the home server 30, can be retrieved, for example, automatically, when other users, with the YZ APP 32′ installed on their computers, view those publisher or third party web pages on which comment(s) were made. This process is provided in greater detail below.

Numerous other servers 50a-50n, 60, 62 and 70 form the environment, in which the system 20 operates to perform the embodiments of the invention. These servers 50a-50n, 60, 62 and 70, include, in addition to the home server (HS) 30, servers of publishers 50a-50n, known as Publisher Servers (P1-Pn) and third parties, known as Third Party Servers (TPS), e.g., the application server 60, and the social network (SN) server 62. There may also be additional servers, such as server 70.

The publisher servers 50a-50n include, for example, servers associated with CNN, with the URL www.cnn.com, Ford, with the URL www.ford.com, and Publisher n, with the URL www.pubn.com. The application server 60, remotely supports the client application, e.g., the YZ APP 32, which may be downloaded from this server 60, at, for example, the URL www.tps1.com. This server 60 may optionally be part of the system 20.

Another TPS, the social network (SN) server 62, is exemplary of a social network, such as Facebook®, MySpace®, and has the URL of www.sn.com, and which operates with the system 20, to transfer data associated with users' utilization of the downloaded application 32, e.g., the YZ APP 32′, as detailed further below. The servers 30, 50a-50n, 60, 62, and 70 typically also have internal storage media and/or are associated with external storage media. In a typical environment, the system 20 is independent of, and not related to or controlled by, the parties associated with the publishers (represented by publisher servers P1-Pn 50a-50n) and the social network server 62, and in some instances, the application server 60.

The additional server 70 hosts a website associated with the disclosed subject matter. For example, the server 70, hosts a web site and web pages associated with the YZ APP (32, 32′), both at the server (YZ APP 32) and client (YZ APP 32′) sides of the network 15. This server 70 is known as the YZ Server, with a URL of www.yzserver.com. Web browsers (also known as browsing applications, browser applications, or browsers, and used interchangeably herein) of computers linked to the network 15 can be directed to the web site hosted by this server 70 to view the various comments (on the aggregated web documents associated with the server 70) which have been posted on various web pages, e.g., the web page of CNN 50a′ (cnn.com, and specifically, “edition.cnn.com . . . ” in FIG. 1. From this web site (and web pages) hosted by the server 70, users can redirect their browsing applications to the web pages on which comments have been posted. This YZ Server 70 may be part of the system 20.

For example, the server 70, aggregates information associated with users, web pages and comments made to the various web pages, may also be programmed to facilitate group commenting, private commenting viewable only to specific users, as well as other types of user or group specific commenting that may associate groups of users with privately created web documents. These groups and private commenting sessions may, through the server 70, link the users associated with these groups with similar web sites or web pages in addition to creating customizable web documents for users with similar commenting preferences and or related browsing histories.

The server 70 may be programmed to notify the users of these groups. The server 70 may also be programmed to place all of these users in contact with each other, via a chat room, a temporarily created web document, or automatically create a group of these users (in accordance with their desires) through social media grouping functions, such as Facebook®, Google Groups, or the like. By creating these groups, users have the ability to communicate with each other over the network 15. In this case, the server 70 is part of the system 20, with access to the home server 30 and all components therein.

The servers 30, 50a-50n, 60, 62, and 70 are linked (either directly or indirectly) to an endless number of other servers and the like, via the network 15. The servers, including publisher servers P1-Pn 50a-50n, the home server 30, and servers 60, 62, and 70 are linked to the network 15, so as to be in electronic communication, both directly and indirectly with each other and any other servers and/or computers, computer systems and the like associated with the user computers 41-43 via the network 15. While single servers are shown, each of the aforementioned servers may be represented by multiple servers, components and the like.

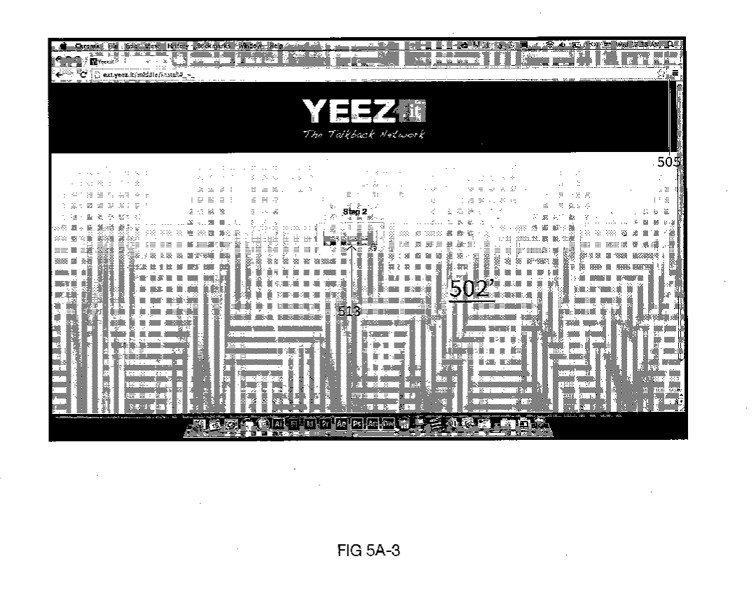

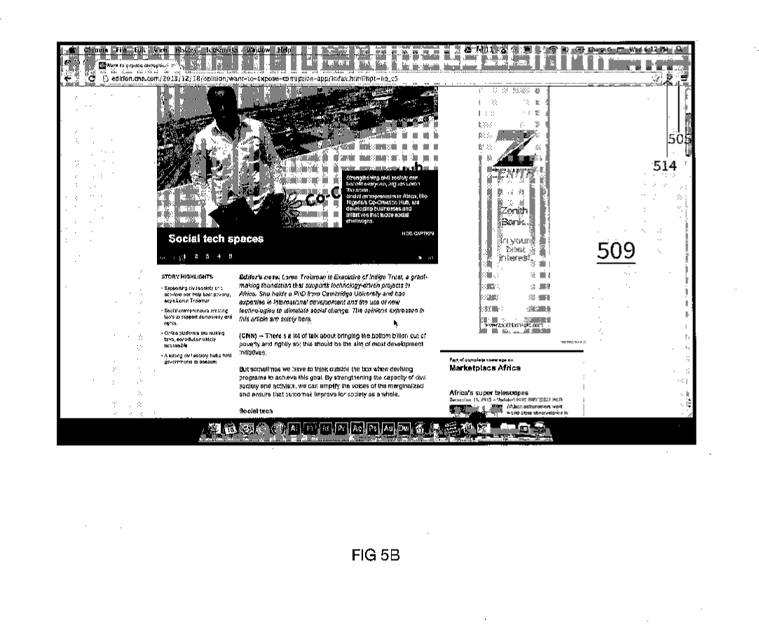

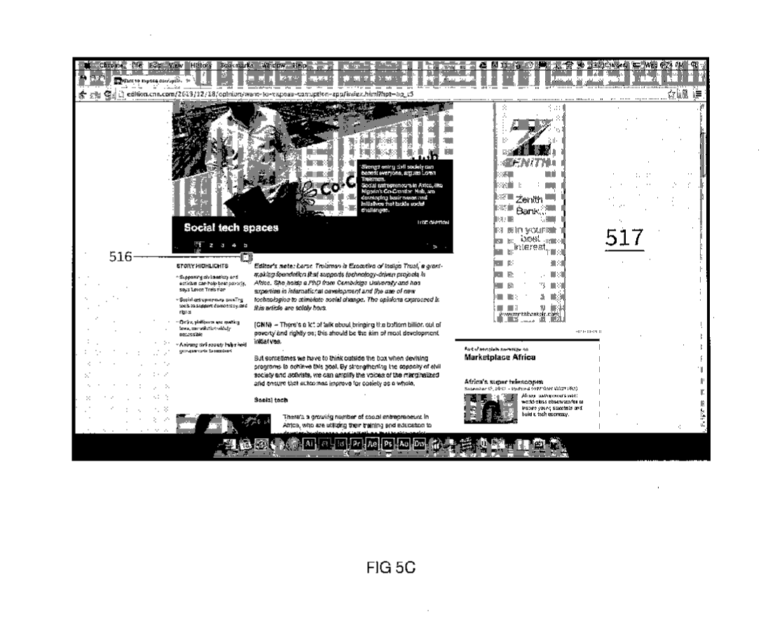

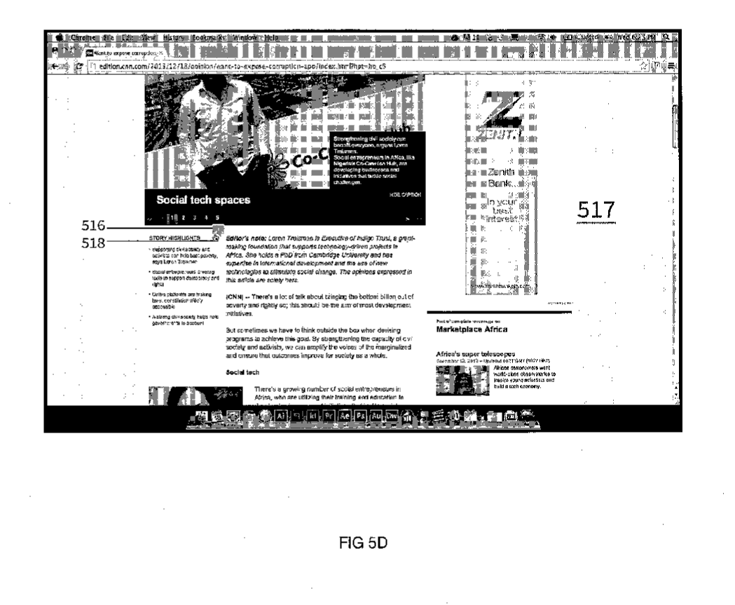

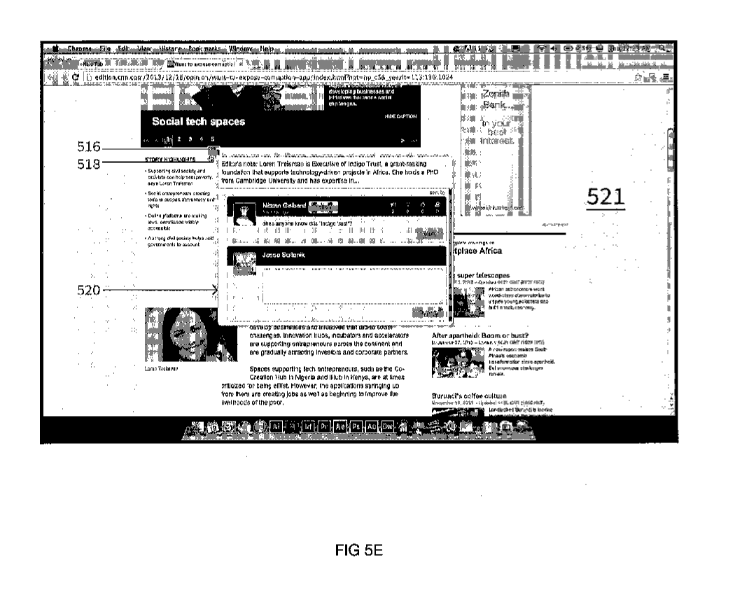

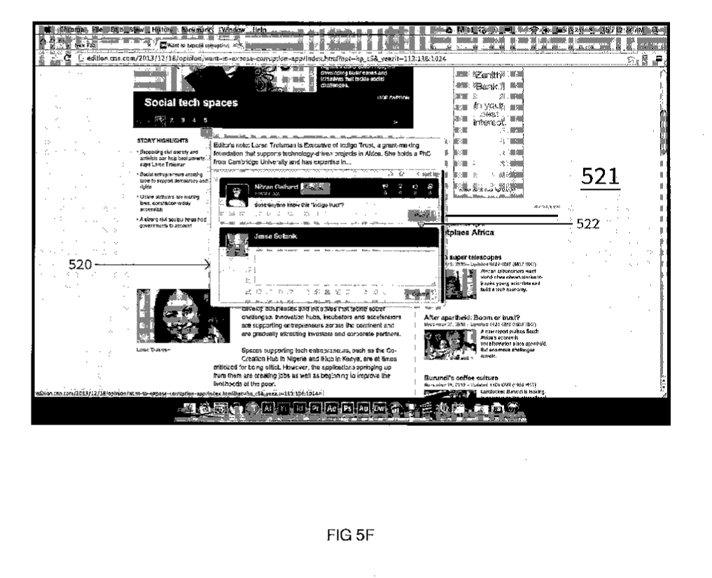

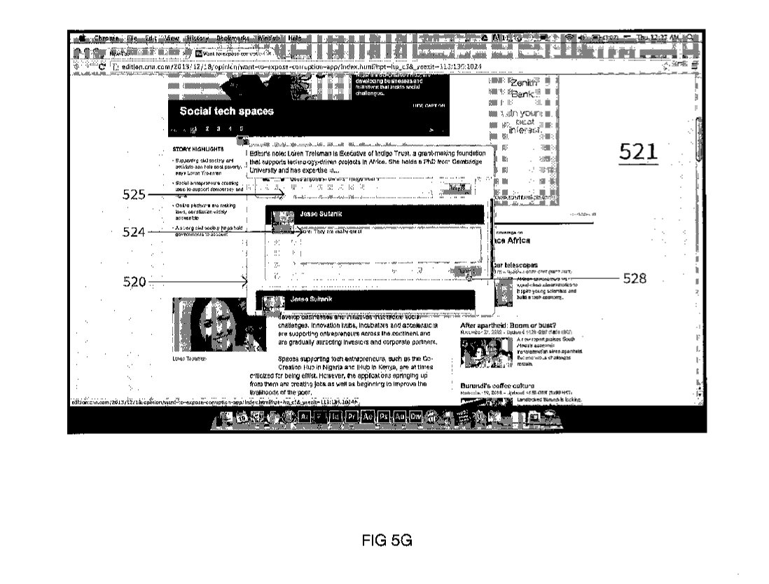

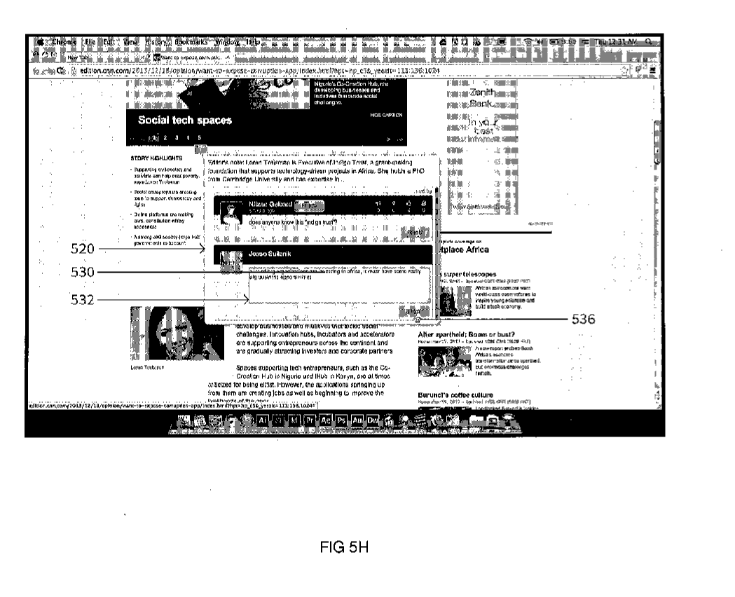

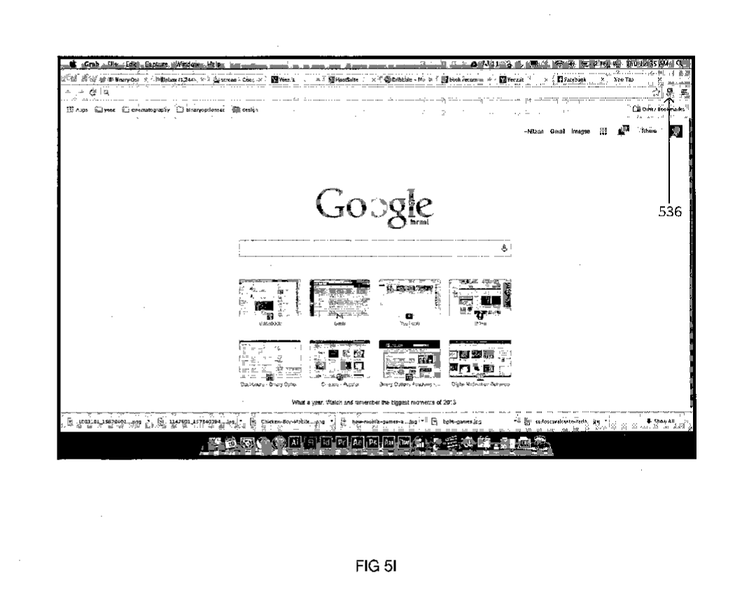

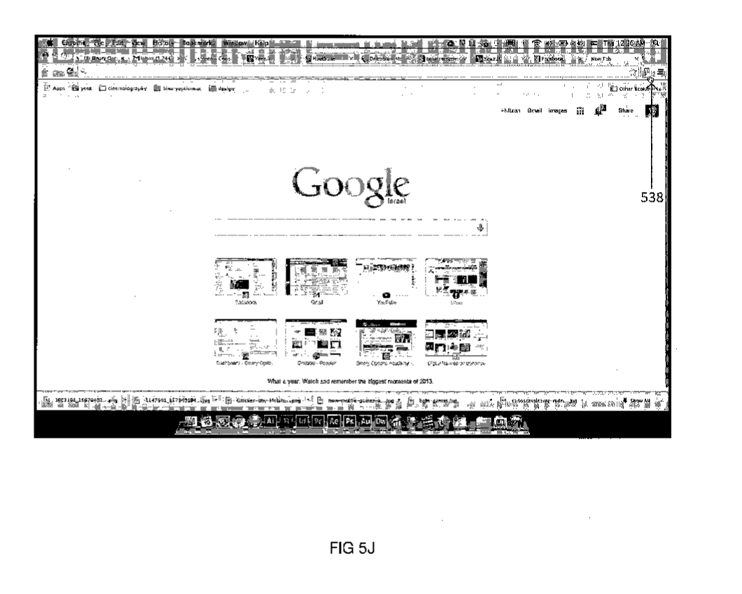

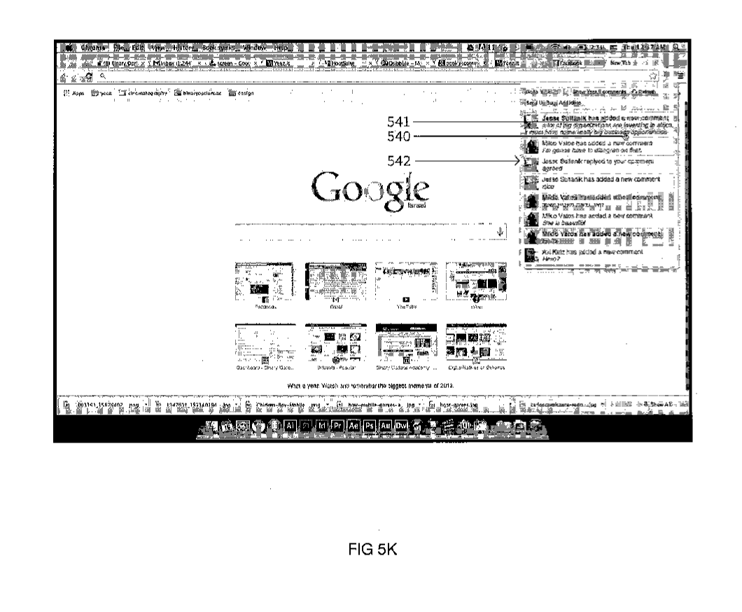

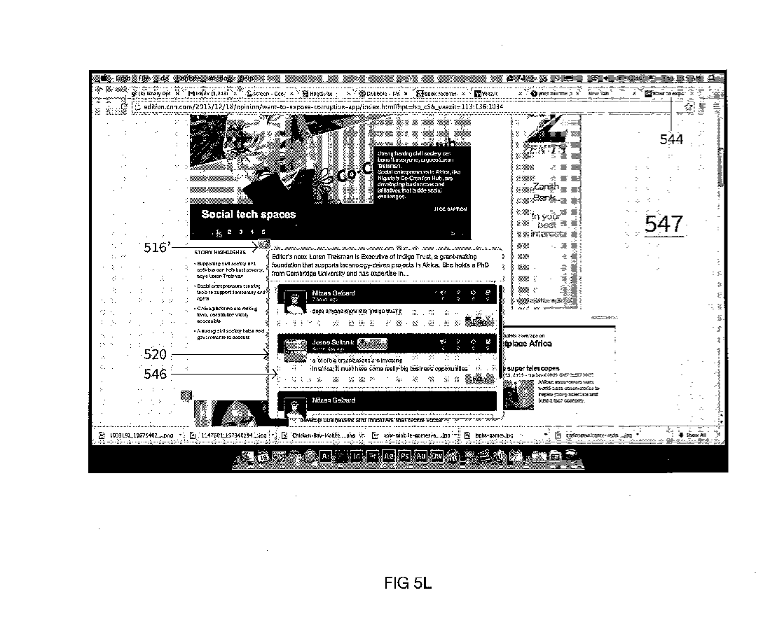

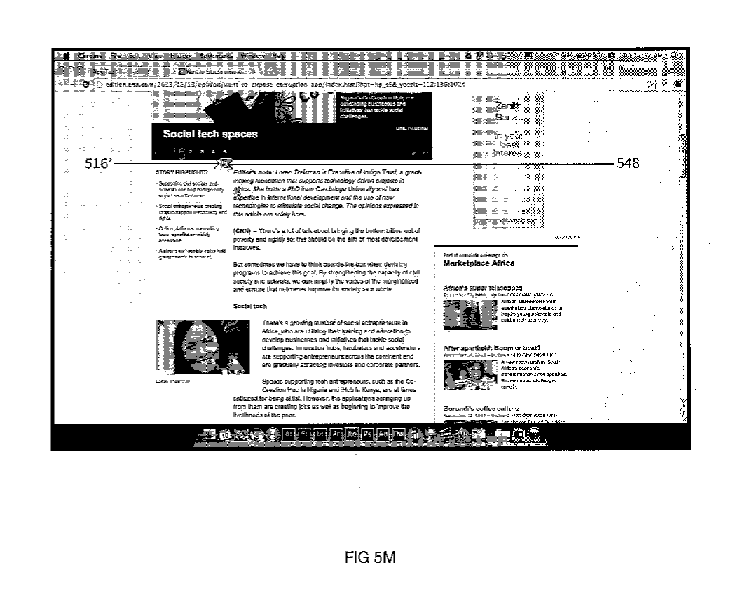

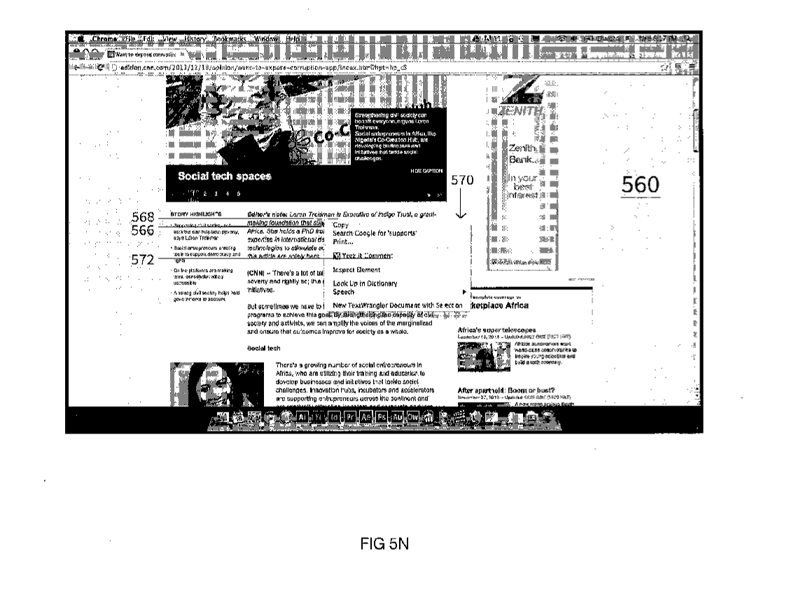

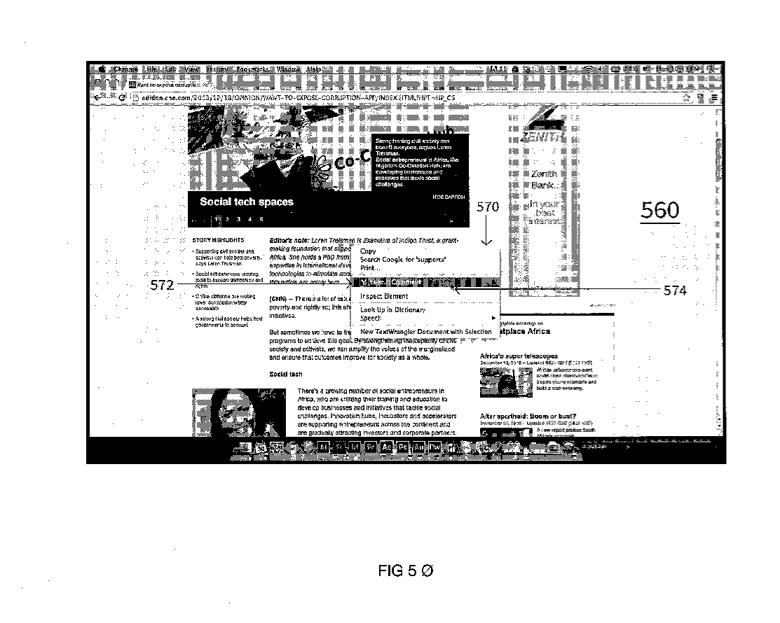

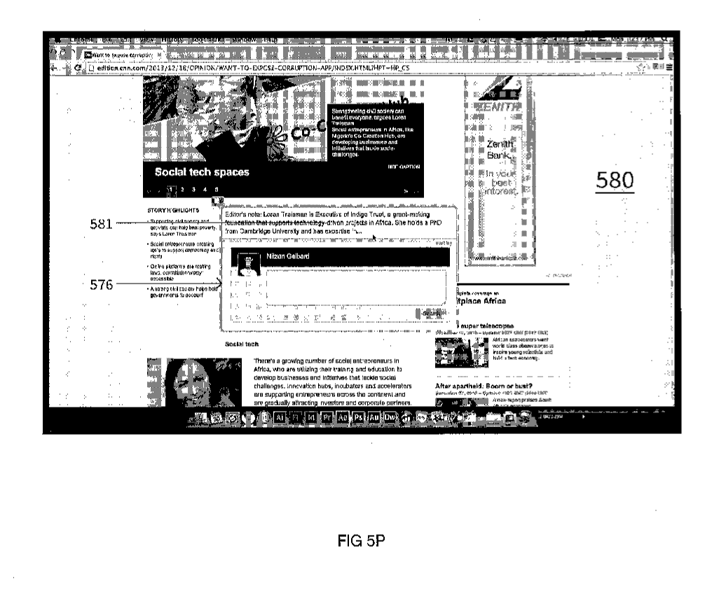

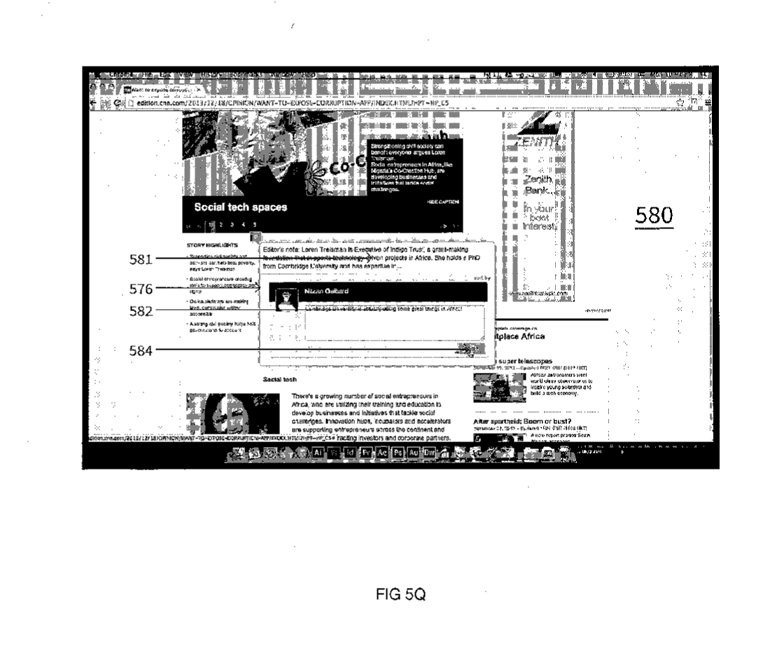

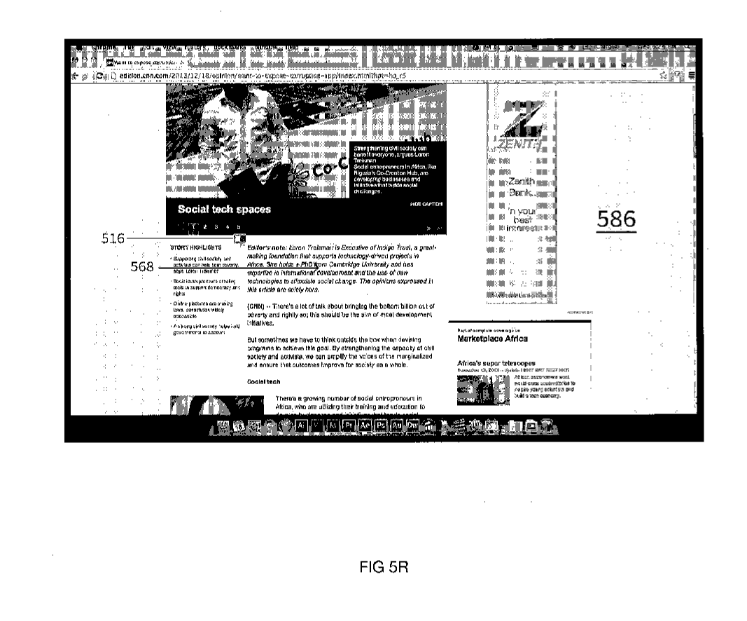

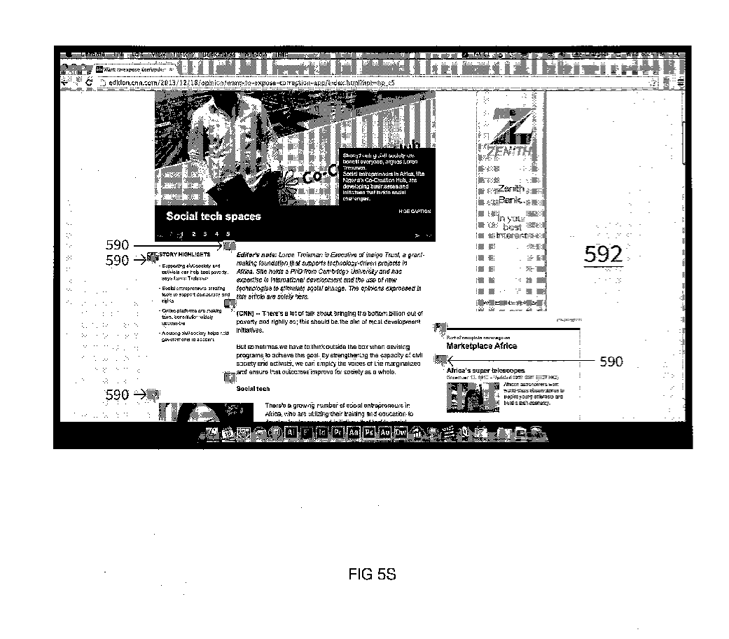

For example, as shown in FIG. 1, user1 41(whose email address is user1@abc.com), user2 42 (whose email address is user2@pqr.com), and user3 43 (whose email address is user3@xyz.com) have the browsing applications (e.g., Internet Explorer® by Microsoft, Google® Chrome®), also referred to herein as browsers, of their computers 41, 42, and 43 directed to the web site CNN 50a′, of the URL, www.cnn.com, which is hosted by publisher server P1 50a of CNN. User1 41, user2 42, and user3 have their browsers directed to and are viewing a web page, for example, shown in FIG. 5B, hosted by CNN.com with the URL “edition.cnn.com/2013/12/18/opinion/want-to-explore-corruption-app/index.html?hpt=hp_c5”. This URL is represented in a shortened manner in FIG. 1 as “edition.cnn.com . . . ” for the user computers 41, 42, 43.

Additionally, user1 41 and user3 43 have installed the YZ APP 32 on their respective computers, such that the YZ APP 32′ is running on these respective computers 41, 43, and accordingly, over the CNN website 50a′. There is an interactive web document 509 overlying the web page of the website 50a′(FIG. 1), which is being browsed. This overlying interactive web document is, is running independently of the underlying web page or web site, without any change to the nature of the underlying webpage or website, e.g., CNN.com 50a′. The YZ APP 32′ may also be run over web sites and web pages, also including those which play audio and video alone or in combinations, the audio and video playing in streams, such as movies, as well as live and recorded events, performances and the like.

Remaining briefly in FIG. 5B, it should be noted that user2 42, has not downloaded the YZ APP 32 onto his computer. As a result, element 514 does not appear on the browser tool bar 505, and accordingly, user2 42 is not viewing the interactive web document 509, but rather, is viewing the standard cnn web page of the URL “edition.cnn.com.”

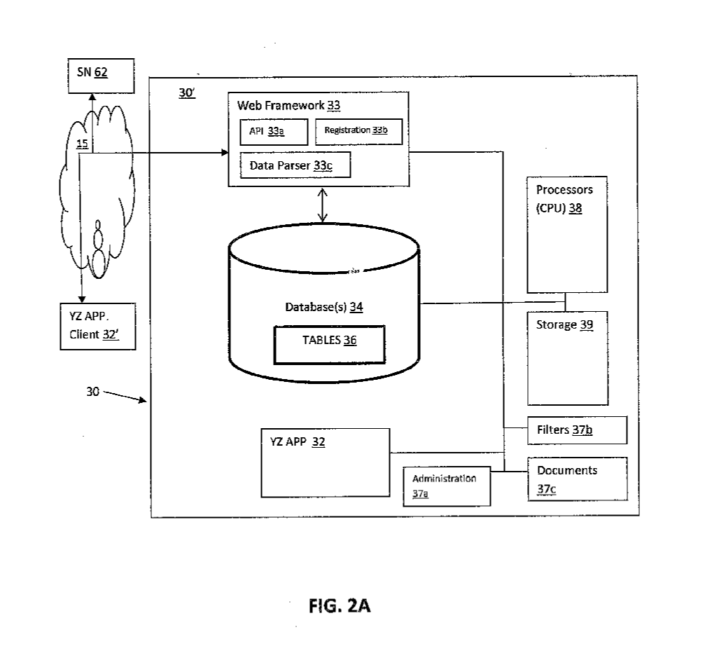

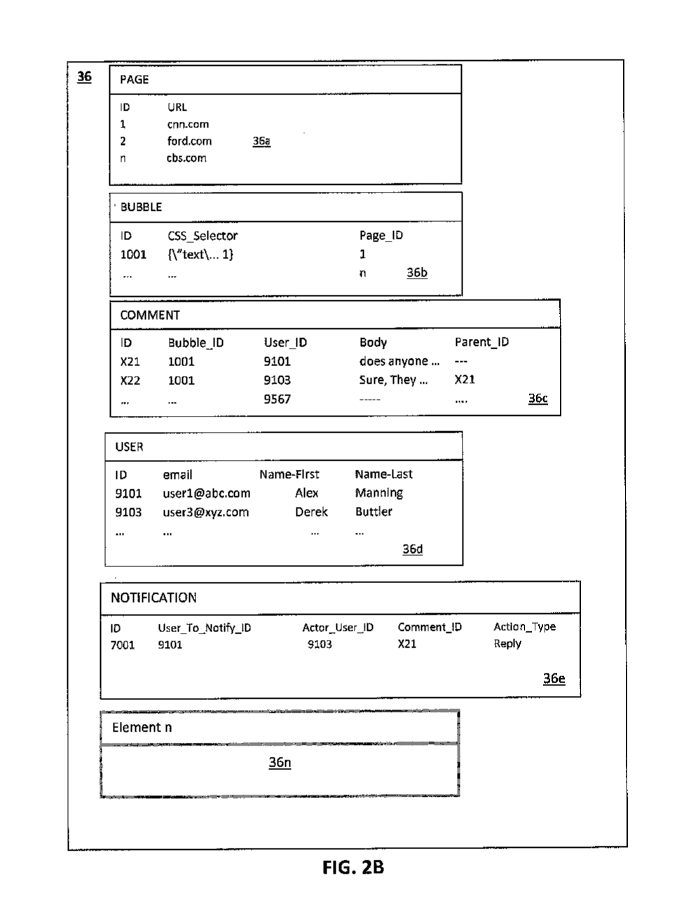

Turning also to FIG. 2A, the system 30′ of the home server 30 (of the system 20) interacts with, and supports the client, the YZ APP 32′ (for example, running on a user computer, such as the computer 41, 43 of the respective user, user1 41, and user3 43, as shown in FIG. 1), at a client side of the network 15. The home server 30 includes, for example, modules/components for supporting the web framework 33. This web framework 33 communicates directly with the YZ APP 32′, in order to retrieve and transfer data to the YZ APP 32′ from another component of the home server 30, the database 34, that the YZ APP 32′ does not communicate with directly.

Attention is now directed to FIG. 2B, in which the database 34 is displayed. The database 34 includes tables 36a-36n from which information regarding users of the YZ APP 32′, comment icons and their host webpages, comments and notifications, and other data types, can be retrieved from various tables in which these and other kinds of data are stored. The organization of these, as well as supplementary data, can be viewed in FIG. 2B. All new incoming data, for example, associated with a new user, comment, bubble, URL, and the like, is given a unique identifier (ID), so that it can be referred to in other tables and accessed by the YZ APP 32′ via the web framework 33.

The web framework 33 is the component of the home server 30 responsible for communicating with each downloaded YZ APP 32′ and for retrieving data in relation to received GET request(s) from the YZ APP 32′. The GET requests, once received, cause the web framework 33 to automatically search the database 34 of the home server 30 for the data requested by the YZ APP 32′ in the GET request. In response to AJAX HTTP GET requests, the web framework 33 returns an AJAX HTTP message to the YZ APP 32′. The AJAX HTTP message, which, when containing a table that includes data, causes the YZ APP 32′ to display comment icons, and can also cause the display of other activatable icons and content, on the monitor (of the computer) of the user. The web framework 33 is able to send and receive data via a direct data transfer link to the database 34 of the home server 30 and to each YZ APP 32′. While action on a single GET request has been detailed above, this is exemplary of the handling of all GET requests by the system 20/30′ (the system 20/30′ referred to hereinafter by element number 30′, the system 30′ of the home server 30, shown in FIG. 2A, with the system 20 including the home server 30 and the system 30′ thereof). The system 30′ can process one or more GET requests at the same time.

The web framework component 33 is, for example, a software framework, which supports, websites, web applications, such as the YZ APP 32, web services and web resources. The web framework component 33 is programmed to either sort, retrieve and or return relevant data in accordance with each AJAX HTTP GET and POST request received from the YZ APP 32′. This web framework component 33, for example, provides the YZ APP 32′ access to the resources and data stored in the database 34 of the home server 30 as well as templating frameworks, session management and code reuse.

Within the web framework 33 is an Application Programming Interface (API) module 33a, a registration module 33b, and a data parser 33c. The API module 33a functions to specify how the system 30′ requests and retrieves data from servers and other computers and the like outside of the systems 30′, 20. The API module 33a also functions to facilitate the interaction of the various software, components, modules, with each other, and also interactions with other servers and the like outside of the system 20, such as the social network server 62. The registration module 33b functions to handle manual registrations. The data parser 33c functions to read information, data, and the like, in various formats, test, graphics, and the like, and parse the data and information and information into portions, units, segments or other divisions usable by the web framework and other components of the system 30′ for their processes, functions, operations, and the like.

While the web framework 33, database 34 and YZ APP 32 are all shown as components of the system 30′, and more specifically of the home server 30, any one or more of these components could be located elsewhere within the system 20, or outside of the system 20 for that matter, and the system 20 could still deliver the stated functionality. These components may also be multiple components, linked together through the network 15.

The home server 30 also includes, for example, a document module 37a which stores document data such as addresses for images, image data itself and other aspects of the web documents used to support the comments on web pages. There is also a filter module 37b, to edit, toggle on/off, or filter certain comments (e.g., improper language, disparaging or slanderous comments). There is an administration module 37c, which functions to administer all of the components of the home server 30. These modules 37a-37c are accessible by a system administrator, either directly through the system 20, or over the network 15, to allow manual functions, such as adding/changing settings, filtering, and handling of user comments as well as other manipulations, as well as access to any other components of the home server 30 and its system 30′.

The home server (HS) 30 also includes various processors 38, including microprocessors, a Central Processing Unit (CPU), for performing the server functions and operations detailed herein, and storage media 39, either internal or associated therewith. The processors 38 control the operation of the components 32, 33, 33a, 33b, 33c, 34, 36, 37a, 37b, 37c, 39 of the system 30′ of the home server 30. The processors 38 are, for example, conventional processors, such as those used in servers, computers, and other computerized devices. The processors 38 may be arranged to have a central processing unit (CPU), for controlling the system 30′. For example, the processors 38 may include x86 Processors from AMD and Intel, Xenon® and Pentium® processors from Intel, as well as any combinations thereof.

The storage/memory 39 is any conventional storage media. The storage/memory 39 stores machine executable instructions associated with the operation of the components 32, 33, 33a, 33b, 33c, 34, 36, 37a, 37b, 37c, 38 of the system 30′ of the home server 30. The processors 38 and the storage/memory 39, although shown as a single component for representative purposes, may be multiple components, and may be outside of the home server 30 and/or the system 30′ thereof, and linked to the network 15.

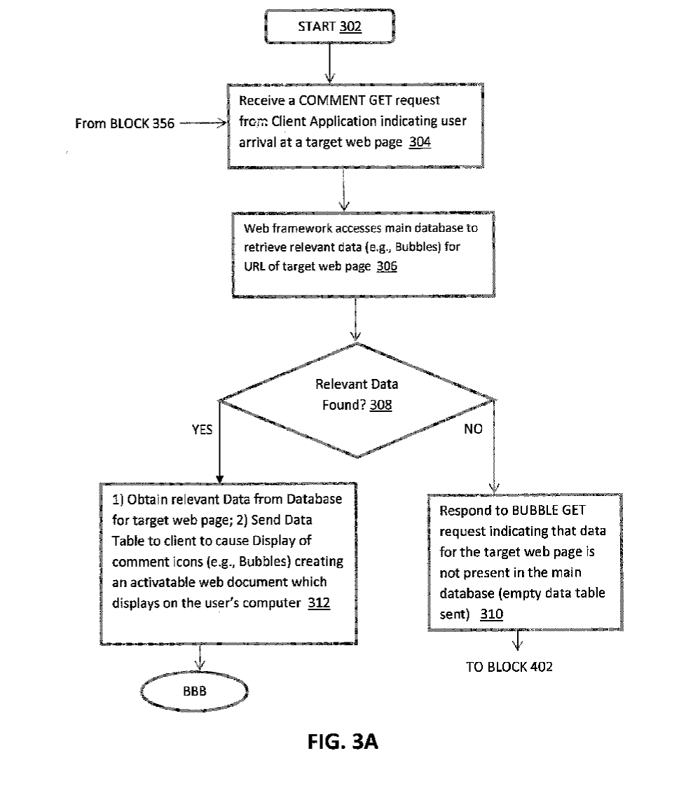

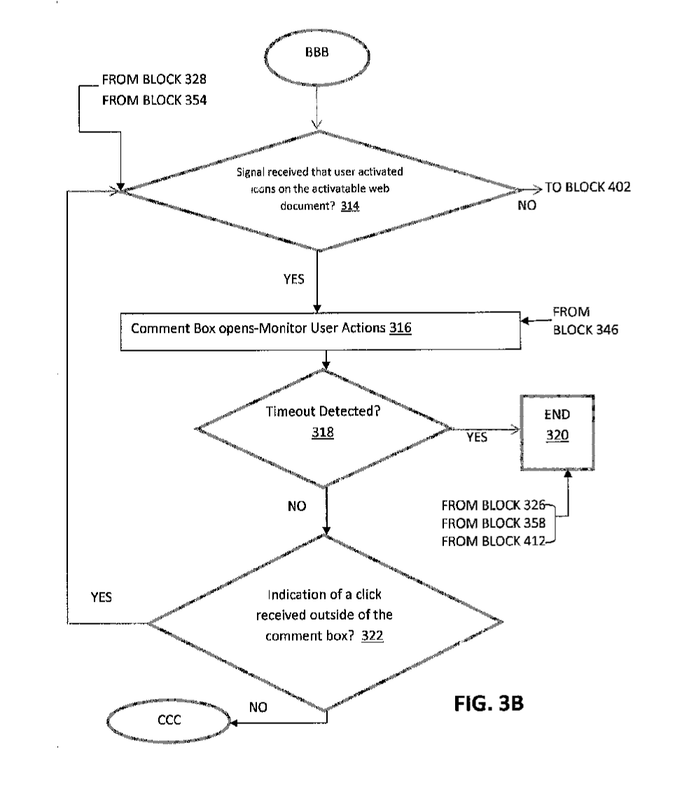

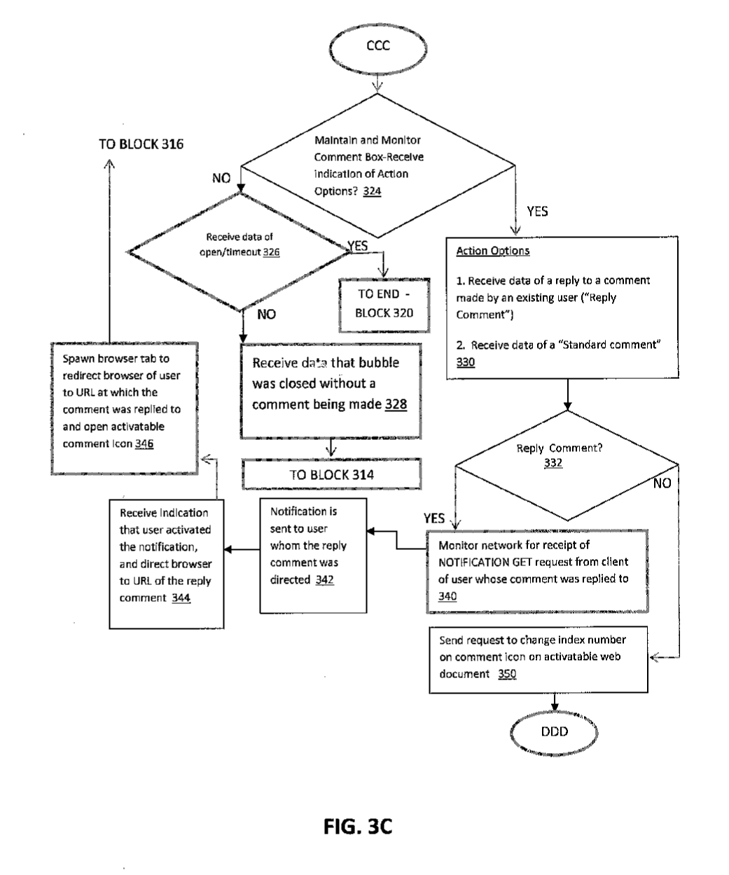

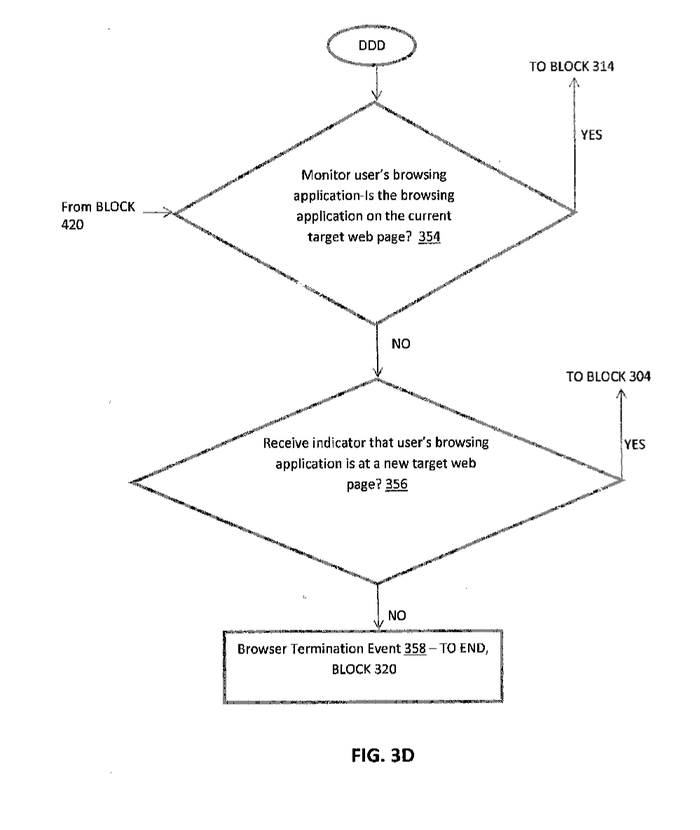

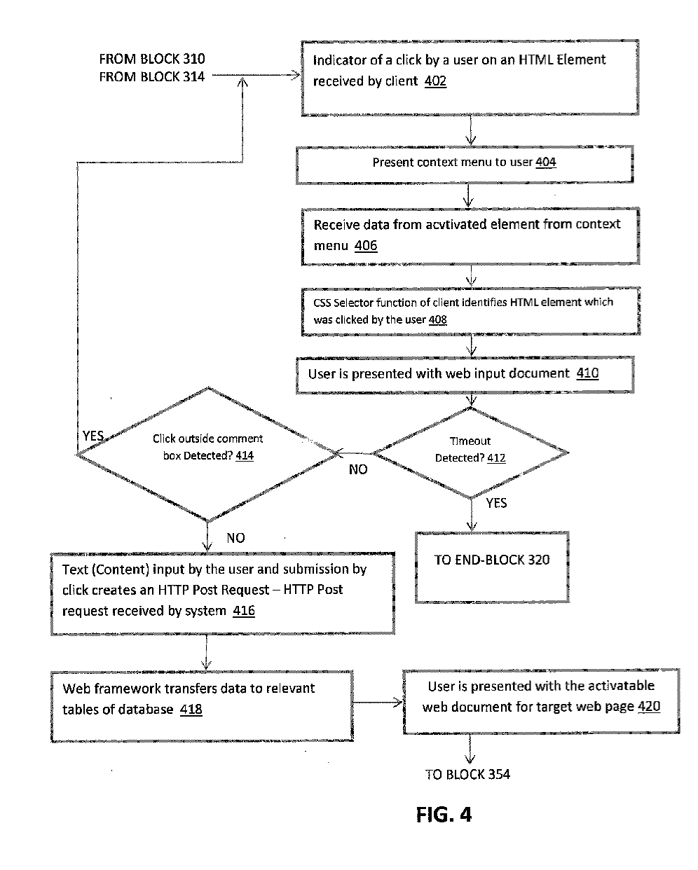

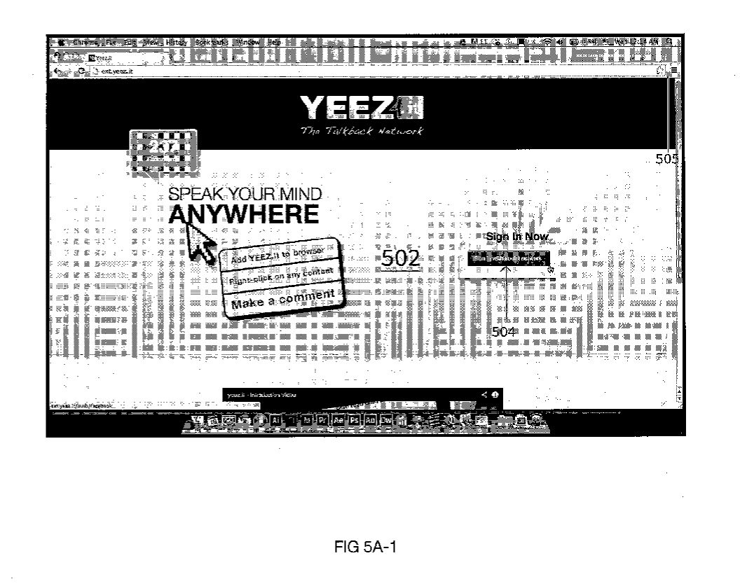

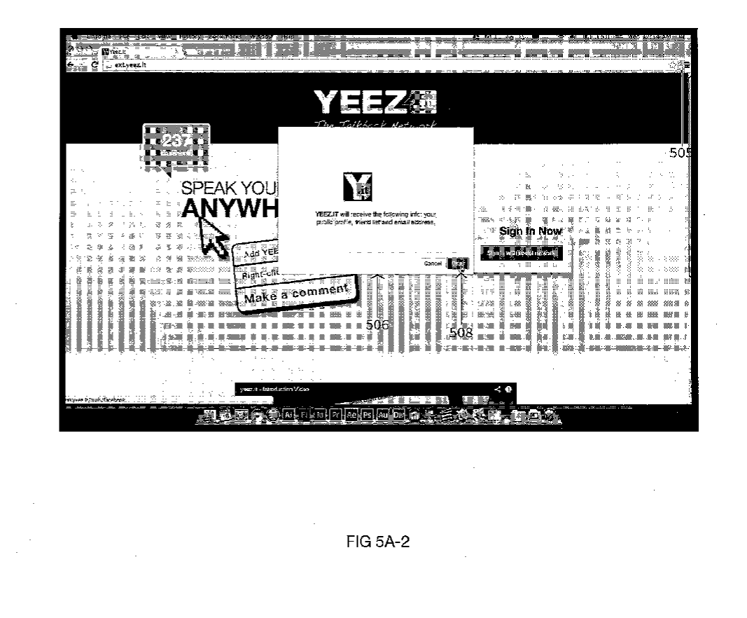

Attention is now directed to FIGS. 3A-3D and FIG. 4, which are flow diagrams detailing a computer-implemented process in accordance with embodiments of the disclosed subject matter. Reference is also made to elements shown in FIGS. 1, 2A and 2B. The process and subprocesses of FIGS. 3A-3D and 4 are a computerized process performed by the system 30′ of the home server 30 (and accordingly, the system 20) in conjunction with the client, for example the YZ APP 32′, deployed, for example on the computers associated with user1 41 and user3 43. The aforementioned processes and sub-processes can be, for example, performed manually, automatically, or a combination thereof, and, for example, in real time. Reference is also made to the screen shots of FIGS. 5A-1 to 5S, which appear on the monitor of the computer of a user, when describing the processes of FIGS. 3A to 3D and 4, as detailed below.

The overlying document and comment process by users is iterative, as users can repeat the action of adding comments to web pages as many times as is desired and as long as the YZ APP 32′ is locally installed (on the user computer).

For description purposes throughout this document, and, for example, for the descriptions of FIGS. 3A to 3D, 4, and 5A-1 to 5S, the following terms, and variations and derivatives thereof, are applicable, as well as applicable to these same terms where used above.

Following the download of the YZ APP 32′, every web site or web page viewed by the user through the browsing application of his computer will be rendered as an “interactive web document”, an “activatable and interactive web document” or a “web input and interactive document,” collectively known as “web documents” or “electronic documents”, in accordance with the “web documents” and “electronic documents” defined above. These web documents and electronic documents facilitate the posting and administration of text, graphics, media, links and the like, for example, in the form of comments. The users can input comments on each web page visited by the browsing application of the computer of the user with the YZ APP 32′. This rendering of the aforementioned web documents will continue as long as the YZ APP 32′ remains installed as a client application on the browsing application of the user's computer.

Each web document viewed by the user through the browsing application of his computer will continue to be rendered as such as long as the YZ APP 32′ remains installed and functioning on the browsing application of the user's computer.

The term “interactive” is used in describing all three types of web documents, mentioned herein and rendered by the system 30′, because having previously downloaded the YZ APP 32′ the user can, at any time in his browsing session, utilize the functionality associated with the YZ APP 32′ as long as it is installed and running on the browsing application of the his computer. The functionality associated with the YZ APP 32′ allows the user to interact with the web page being browsed by, for example, posting a comment on it in an overlying data layer associated with the YZ APP 32′. Each specific web document and the requisite circumstances for their rendering are detailed below.

An “interactive web document” includes web sites and/or web pages to which the browsing application of the user is directed after the user has downloaded an application, for example, the YZ APP 32′, onto his computer (user computer). Thereafter, every web site or web page viewed by the user through the browsing application of his computer will remain an “interactive web document” as long as the YZ APP 32′ is installed and running on the user's browsing application and there are no “comment icons” or “comment boxes/windows” (defined below) present on the web page being viewed.

A “comment icon” is an icon displayed as an overlay to a certain website or web page indicating that another user of the YZ APP 32′ has previously made a comment on that website or web page. When “comment icons” are present on the display monitor of a user computer, the user is viewing either an “activatable and interactive web document” or a “web input and interactive document”. In these web documents the user can activate the “comment icon(s)” (by clicking thereon) or the user can utilize the functionality associated with the YZ APP 32′. If the user activates (clicks on) a “comment icon”, a “comment box” is generated and the user will be viewing a “web input and interactive document”. The user can view “comment icons” on both an “activatable and interactive web document” and a “web input and interactive document” but can only view a “comment box” on a “web input and interactive document”.

A “comment box” (also referred to as “comment window” herein) includes a text input field, and is the primary component of a “web input and interactive document”. A “comment box” is generated, for example, following the user's activation (click on) of a comment icon or following the user's selection of a certain menu option, e.g., “Yeez.it comment” (FIG. 5), from the browser context menu.

An “activatable and interactive web document” includes web sites and/or web pages to which the user's browsing application is directed after the user has downloaded an application, for example, the YZ APP 32′, onto his computer (user computer). This “activatable and interactive web document” refers to a web page, viewed by the user, on which comment icons are present and are displayed on the monitor of the user as an overlying data layer. These comment icons indicate that a user of the YZ APP 32′ has previously inputted a comment in the overlying data layer associated with the YZ APP 32′ without changing the nature of the underlying web page to which the user's browser is directed. While viewing an “activatable and interactive web document” the user can activate comment icon(s) by clicking on them or utilize the functionality associated with the YZ APP 32′. As long as there are only comment icons appearing on the web page to which the user's browsing application is directed, the user is viewing an “activatable and interactive web document.”

A “web input and interactive web document” includes web sites and/or web pages to which the user's browsing application is directed after the user has downloaded an application, for example, the YZ APP 32′, onto his computer (user computer). The user views a “web input and interactive document” after he has activated certain components of the YZ APP 32′, for example, by selecting a certain option, e.g., “Yeez.it comment” from the browser context menu or following the user's click on a comment icon. By selecting “Yeez.it comment” (FIG. 5) or by clicking on a comment icon, the user has generated a comment box which, when appearing on the web page to which the browsing application of the user is directed, renders a “web input and interactive document”. A “web input and interactive document” is rendered when a comment box is present on the web page to which the browsing application of the user's computer is directed. Additionally, multiple comment icons may appear, or be present on, a “web input or interactive document”. While viewing a “web input and interactive document”, the user can submit a comment, activate a comment icon or utilize the functionality associated with the YZ APP 32′.

The functionality of the YZ APP 32′, as used herein denotes the ability of the user with the YZ APP 32′ downloaded and running on the user computer (also known as running on the browsing application of the user computer) to post and position comments on the web document overlying the web page or web site being browsed.

The “browsing application context menu” or “browser context menu” is a menu which appears on the monitor of the computer of a user, when the user makes a right click inside of any website or web page.

Prior to the start of the process, the user(s) navigate to a target web page, hosted, for example by the home server 30, or other server associated with the system 20. For example, a target web page 502, to which a user has navigated is shown by the screen shot of FIG. 5A-1, with the URL “ext.yeez.it”. The user clicks on the button 504 on target web page 502, to open a data connection between the system 20, e.g., the home server 30, and the social network server 62, in order to begin the data authentication process of setting up a profile via a third party data link. FIG. 5A-1 also indicates that the browser toolbar 505 does not include the icon of the YZ APP 32, which has not been downloaded.

The user now registers with the system 30′. This registration allows the user to utilize the functionality associated with the YZ APP 32′ when it is downloaded and running on the computer of the user. Registration, for example, is either through the social network, via the social network server 62, or via the system 30′ via the registration module 33b.

Registration via the social network, represented by social network server 62, involves the Application Programming Interface (API) module 33a sending a third party data/authentication request to the social network server 62. The social network server 62, for example, automatically, responds to this request by fetching (gathering or obtaining) information (e.g., username, email, interests and credentials) about the user, e.g., USER1 41 or USER3 43, which is hosted on the social network server 62. Next, the system 30′ prompts the user with a prompt 506, as shown in FIG. 5A-2, regardless of whether the user authorizes the transfer of data requested by the system 30′ of the social network server 62. Following the user's authorization, a click 508 on the OKAY button, an authenticated data connection is made, for example, automatically, with the home server 30, wherein the home server 30 receives the requested information about the user that is stored on the social network server 62, via a data transfer. The home server 30 stores this new user data in the USER table 36d of the database 34 and generates a unique identifier, for the field “ID” in each row of the USER table 36d, of the database 34, for the new user.

Alternately, should the user not register through the social network 62, the user registers through the system 30′ itself, through the registration module 33b of the home server 30. The user enters, for example, three inputs: first name, last name and email address, to set up and register his profile. This profile is stored in the USERS table 36d of the database 34.

Once the user(s), e.g., USER1 41 and USER3 43, have registered with the system 30′, and the system 30′ has generated a unique ID for that user, the system 30′ redirects the user to a second page, shown in FIG. 5A-3, with a URL “ext.yeez.it\middle\instal#_=_”, wherein the user is requested to download the YZ APP 32. At FIG. 5A-3, the icon of the YZ APP 32 is not present on the browser toolbar 505 indicating that the user has not yet downloaded the YZ APP 32.

If the user clicks the button 513 on the web page 502′ of FIG. 5A-3, to download the YZ APP 32, the system 30′, or third party server 60, transfers the application (e.g., data for the YZ APP 32) to the user's computer. With the download complete, the YZ APP 32′ now sits on the functioning browsing application of the user's computer. This successful download is represented in FIG. 5B by an extension icon 514, for example, sitting on the browser toolbar 505 of the browsing application of the user computer.

Following registration with the system 30′ and with the download of the YZ APP 32′ complete, the user is able to utilize the functionality of the YZ APP 32′. For example, the user, via his browsing application, has navigated to the web page, hosted by cnn.com 50a, the web page with the URL: edition.cnn.com/2013/12/18/opinion/want-to-explore-corruption-app/index.html?hpt=hp_c5 (represented in a shortened form in FIG. 1 as “edition.cnn.com . . . ”). The process can now START at block 302 of FIG. 3A. The completed download of the YZ APP 32 coupled with, for example, the login through the “social network connect” or through the registration module 33b, causes the rendering web documents, such as “interactive web documents”, “activatable and interactive web documents” and “web input and interactive documents.”

The process begins at block 302, labeled START, as the user (e.g., user1 41) initiates action of the system 30′ upon the user navigating to a target web page, for example, the page of CNN.com, as shown in FIG. 1. This navigation is detected by the system 30′.

Moving to block 304, once the user has directed his browsing application to a new target web page (e.g., a browser redirect to a new URL, using a search engine, clicking on a hyperlink within a web page, etc . . . ) and once the entire web page of the new URL is loaded, the YZ APP 32′ automatically issues and sends an AJAX HTTP BUBBLE GET request to the home server 30. Alternately, the YZ APP 32′ can send the home server 30′ the AJAX HTTP BUBBLE GET request immediately upon the redirection of the browsing application of the user computer to a new URL or target web page.

Once received by the home server 30, the BUBBLE GET request indicates that the user has arrived at a target web page, for example, a new URL, and the system 30′ responds to the indication by checking for existing comment icons in the database 34 for the web page of the new URL. The new URL includes a new web page from the same web site being browsed. The system 30′ will display, on the monitor of the computer of the user, any comment icons found for that URL (of the new web page), if such comment icons exist, in the database 34. The system 30′, in receiving a BUBBLE GET request from the YZ APP 32′, each time a user visits a new URL, automatically adds that page's URL to the PAGE table 36a of the database 34 and gives it a unique ID, known as the field Page_ID within the new row created by the in the PAGE table 36a of the database 34.

The system 30′ responds to the GET request of the YZ APP 32′ with parsed data (via a data parser 33c which is a component of the web framework 33) regarding whether or not comment icons exist (or bubbles, found in the BUBBLE table 36b of the database 34) for that target web page e.g., “edition.cnn.com . . . ” (FIG. 5B). While searching the BUBBLE table 36b, the data parser 33c reads the information stored in the BUBBLE table 36b, identifies relevant data in accordance with the Page_ID sent by the YZ APP 32′, and, responds with the parsed data to the YZ APP 32′.

Within the system 30′ of the home server 30, GET and POST requests, issued by the YZ APP 32′, are received and handled by the data parser 33c which sits on the web framework 33 of the home server 30. The process now moves to block 306, where the web framework 33, acting via the data parser 33c, accesses the database 34 to retrieve the relevant data, for example, comment icons, also known as bubbles and used interchangeably herein, for the URL of the target web page. The system 30′ is capable of processing multiple GET requests from YZ APPs 32′ simultaneously and contemporaneously, and can do so automatically and in real time.

The Page_ID of the BUBBLE GET request is used by the web framework 33 when it searches the BUBBLE table 36b of the database 34 (as described above, the web framework 33 searches the BUBBLE table 37b once it has established that the URL of the page from which the BUBBLE GET request was sent already has a unique ID identifier). When the web framework 33 inspects the BUBBLE table 36b, the web framework 33 reads the information stored therein, identifies relevant data in accordance with the Page_ID and responds to the BUBBLE GET request by sending the parsed data to the YZ APP 32′.

The process now moves to block 308, where the web framework 33 determines whether there is any relevant data (rows with matching Page_IDs to the Page_ID of the URL from which the YZ APP 32′ sent the BUBBLE GET request) in the BUBBLE table 36b of the database 34 for the URL from which the BUBBLE GET request was sent.

Should relevant data not be found for the BUBBLE GET request (no matching URL is found in the PAGE table 36a of the database 34), the process moves to block 310. Specifically, since relevant data is not found, the web framework 33, responds to the BUBBLE GET request with parsed data that does not contain any relevant data for the URL of the target web page that was browsed to by the user. This indicates that there are no existing comment icons for the URL that was received, e.g., the target web page, the web page of CNN 50a′ with the URL “edition.cnn.com . . . ”, shown in FIG. 5B. Since there were no existing data for the URL that was received, the user continues to view an interactive web document as no comment icons have been added to the display monitor of the user. As a result of the YZ APP 32′ not receiving any relevant data for the target web page, there are not any additions in the form of comment icons to the monitor display of the user and the process moves to block 402, in accordance with that shown in FIG. 4, and detailed below.

Returning to block 308, with relevant data found at block 308, the process moves to block 312a. At block 312a, the system 30′: 1) obtains relevant data from the database 34 for the target web page (relevant data being found in rows of the BUBBLE table 36b of the database 34 that contain matching Page_IDs to the Page_ID of the URL from which the YZ APP 32′ of the user sent the BUBBLE GET request); and, 2) in an AJAX HTTP response message, sends the parsed data to the client that contains the relevant data found (relevant data being data stored in rows of the BUBBLE table 36b that have matching Page_IDs to the Page_ID from which the YZ APP 32′ sent the BUBBLE GET request) at block 308. Since the return message contains relevant data for the target web page, the YZ APP 32′ displays the relevant data in the form of comment icons (e.g., bubbles) on the display monitor of the user computer, at block 312b. In presenting comment icons on the user's monitor, the system 30′ has rendered an activatable and interactive web document.

This process of blocks 312a and 312b includes reading the BUBBLE table 36b of the database 34, identifying relevant data by matching the Page_ID of the URL from which the BUBBLE GET request was sent to rows which contain the same Page_ID, and sending parsed data that contains information regarding existing comment icons for the target web page being viewed by the user to the YZ APP 32′. This causes comment icons (e.g., bubbles) to appear on the monitor of the computer of the user. Comment icons appear on web documents in accordance with information stored in the CSS_Selector column of the BUBBLE table 36b. The CSS_Selector column of the BUBBLE table 36b contains data regarding where the comment icon(s) 516 are to be positioned on the display monitor of the user (e.g., to the upper left corner of a paragraph), as shown in FIG. 5C. The system 30′ presents comment icon(s) 516 on an activatable web document 517 (as well as the interactive web document 517) to the user, as shown in FIG. 5C. For example, multiple comment icons can appear on the display monitor of a user computer simultaneously (see FIG. 5S).

In responding to BUBBLE GET requests of the YZ APP 32′, the home server 30 (system 30′), acting via the data parser 33c of the web framework 33, returns parsed data to the YZ APP 32′ in an AJAX HTTP response. The parsed data in these return messages include at least information regarding: Page_ID, Bubble_ID and CSS_Selector.

From block 312b, the process moves to block 314, where it is determined whether a signal, data, or other indicator, has been received that the user activated, for example, clicked on, a comment icon 516 appearing on the activatable and interactive web document 517, which the user was presented at block 312. This signal comes from a click 518 by the user on the comment icon 516 as shown in the activatable and interactive web document 517, in FIG. 5D.

If signals, data or indicators are received other than a comment icon activation, the process moves to block 402 (FIG. 4) and the process resumes in accordance with that detailed below.

However, if a signal, data or indication is received that the user has activated a comment icon (the click 518 as shown in FIG. 5D), the YZ APP 32′ sends the home server 30 (system 30′) an AJAX HTTP COMMENT GET request. This time the AJAX HTTP COMMENT GET request includes the Bubble_ID (instead of a Page_ID as in a BUBBLE GET request) of the activated comment icon 516 so the system 30′ will retrieve the comment(s) and user(s) information stored inside. In this case (where the system 30′ recognizes that a comment icon has been activated—due to the receipt by the home server 30 of a COMMENT GET request), the data parser 33c of the web framework 33 of the home server 30 searches the COMMENT table 36c of the database 34 for rows that contain matching Bubble_ID(s) to the Bubble_ID of the comment icon that was activated (clicked on) by the user.

When searching the COMMENT table 36c for rows with matching Bubble_IDs, the web framework 33, acting via the data parser 33c, will read the table, identify relevant data in accordance with the Bubble_ID sent by the YZ APP 32′ and send, in an AJAX HTTP message, a response to the YZ APP 32′ containing the parsed data which includes the user(s) and comment(s) information for the comment icon that was clicked on. The data inside a row from the COMMENT table 36c of the database 34, as shown in FIG. 2B, includes, at least, a unique identifier ID, a Bubble_ID, a User_ID, the body of the comment, and, if the comment was a reply comment (detailed below), a Parent_ID.

The process moves to block 316, where a comment box 520, as shown on web input and interactive document 521 in FIG. 5E, now opens on the user's computer monitor in response to the user's activation (click on) 518 of comment icon 516. Additionally, at block 316, the system 30′ monitors user actions with respect to the comment box.

The process moves to block 318, where it is determined whether a timeout is detected. A timeout occurs when, for example, a predetermined time period for user action expires causing a temporary connection termination due to which the user can no longer undertake an action with regard to the system 30′. Should a timeout be detected, the process moves to block 320 and the process ends.

Should a timeout not be detected, the process moves to block 322, where it is determined if an indication of a click outside of the comment box 520 has been received by the system 30′. If a click has been detected, the process returns to block 314, where it resumes as detailed above. If a click is determined not to have been received by the system 30′, the process moves to block 324.

At block 324, the user has clicked on 518 the comment icon 516 of FIG. 5E, and the system 30′ presents the user with a comment box 520 on a web input and interactive document 521 from which the user has action options. Remaining at block 324, the comment box 520, as it appears in the web input and interactive document 521 of FIG. 5F, is maintained and monitored. The system 30′ receives a signal that the user has either: 1) clicked on the reply button, 522 of FIG. 5F, which generates an indicator 525 of FIG. 5G, so that the user can now submit a reply comment, as opposed to a standard comment, and begins inputting text 524 for the reply comment; or, 2) goes directly to the text input field 532 of FIG. 5H where the user can submit a regular comment, and the user inputs text 530 into the text input field 532.

If signals, data and indicators are received confirming the undertaking of an action option, the process moves to block 326. At block 326, it is determined if data of a time out has occurred while the comment box was open. If a timeout was detected, the process moves to block 320, where it ends, as detailed above. Otherwise, the process moves to block 328, where data is received that the bubble was closed without a comment being made. The process then moves to block 314, where it resumes as detailed above.

Returning to block 324, if signals, data and indicators are received confirming the undertaking of an action option by the user, the process moves to block 330. At block 330, the system 30′, following the user's click on the submit button 522 in the comment box 520 of FIG. 5G, or his click on submit 536 in the comment box 520 of FIG. 5H, receives from the YZ APP 32′ of the user, a POST request which contains data pertaining to either: 1) the reply comment text input 524 of FIG. 5G plus a unique comment ID, the user's ID, the Bubble_ID and a Parent_ID value; or, 2) the standard comment text input 530 of FIG. 5H plus a unique comment ID, the user's ID, the Bubble_ID and a blank Parent_ID value. In either form, the data received by the system 30′ is transferred by the web framework 33 to the COMMENT table 36c of the database 34 and a new row in the COMMENT table 36c is created.

Moving to block 332, the system 30′ now determines whether the comment received in the POST request is a reply comment or standard comment. The system 30′ makes this determination by reviewing the Parent_ID field of the new data row that was created in the COMMENT table 36c of the database 34. If there is a value in the Parent_ID field, the system 30′ determines that a reply comment was made. Whenever there is a value for the Parent_ID field of the new row in the COMMENT table 36c, the system 30′ recognizes that a reply comment was made and automatically creates a new row in the NOTIFICATION table 36e of the database 34 wherein the value of the Action Type field is, for example, “reply”.

In positively identifying a value in the Parent_ID field, the process moves to block 340, where the network 15 is monitored for receipt of a NOTIFICATIONS GET request from the client application, e.g., the YZ APP 32′, of the user whose comment was replied to. For example, at intervals, e.g., every 60 seconds, the YZ APP 32′ (acting in accordance with preprogrammed instructions) sends a NOTIFICATION GET request (which can retrieve multiple notifications) to the home server 30. Each NOTIFICATION GET request is handled by the web framework 33, which takes the User_ID of the YZ APP 32′ from which the NOTIFICATION GET request was sent and searches the NOTIFICATION table 36e of the database 34, for matching IDs listed in the User_To_Notify_ID field.

The process then moves to block 342, where existing notification(s) are identified by the web framework 33 and sent to the YZ APP 32′ of the user, to whom the reply comment was directed. For example, the data parser 33c of the web framework 33 reads the NOTIFICATIONS table 36e, identifies relevant data (relevant data being rows from the NOTIFICATIONS table 36e with matching User_TO_Notify_IDs to the unique User_ID whose' YZ APP 32′ sent the NOTIFICATIONS GET request) and returns parsed data to the YZ APP 32′ containing all the relevant notifications with matching User_To_Notify_IDs. The YZ APP 32′ then conveys to the user that new notification(s) exist through an indicating icon 536 as it appears in FIG. 5I, on top of the extension icon (514 from FIG. 5B) on the browser toolbar 505 (FIG. 5B) of the browsing application of the user.

The process now moves to block 344, where the system 30′ receives an indication that the user has: 1) clicked on the icon indicating that a new notification exists (the click represented by element 538) as is shown in FIG. 5J which generates the drop-down notifications menu 542 as is shown in FIG. 5K; and, 2) activated (clicked on) 540 the new notification 541 from the drop-down notifications menu 542 as shown in FIG. 5K. Once the user has clicked 540 on the new notification 541, the process moves to block 346 wherein the YZ APP 32′ spawns a new browser tab 544 in FIG. 5L. The click 540 causes the browser to redirect to the URL at which the user's comment was replied to and automatically opens the activatable comment icon 516′, in which the reply comment and the user's original standard comment are stored.

For example, following the user's click 540 on the new notification 541 (FIG. 5K), the system 30′ sends a SPECIAL COMMENT GET request to the home server 30. This SPECIAL COMMENT GET request, in addition to retrieving all the comment icons from the BUBBLE table 36b for the page to which the user has been redirected, commands or causes the web framework 33 to include a directive for the YZ APP 32′ to activate (open) the comment icon 516′ in which the user's comment has been replied. Clicking on a notification 541 from the drop-down notifications menu 542 causes the system 30′, acting through YZ APP 32′, to automatically present the user with a comment box 520 in a web input and interactive document 547 (FIG. 5L). The automatic display of the comment box 520 on a web input and interactive document due to the SPECIAL COMMENT GET request occurs rather than the presentation of an activatable and interactive web document as would have been the case had the user directed his browser to the same page on his own. In automatically displaying the user with a web input and interactive document, the process moves to block 316, where it resumes as detailed above.

Returning to block 332, if it was determined that a standard comment was made (the web framework 33 did not identify a value in the Parent_ID field in the new row of the COMMENT table 36c), the process moves to block 350. At block 350, the index number (index number=2) 548, that appears on the comment icon 516′, as shown on FIG. 5M, which hosts the new comment, is increased by the integer “1”. The changing of the index number is accomplished while the web framework 33 adds a row to the COMMENT table 36c of the database 34. Since the addition to the COMMENT table 36c includes the Bubble_ID of the comment icon that was activated in block 314, and no Parent_ID value exists, the system 30′ will automatically update the index number appearing on the comment icon, resulting from a standard comment being made. From block 350, the process moves to block 354.

At block 354, the browsing application of the user is monitored to determine whether the browsing application is on the current target web page. If browser navigation is not detected (a BUBBLE GET request is not received by the system 30′), the process returns to block 314, and the process continues as detailed above.

Upon detection of a browser redirect from the target web page to a new target webpage, the process moves to block 356. At block 356, it is determined if the browsing application is now at a new target web page. If the browsing application of the user is at a new target web page, the YZ APP 32′ generates a new AJAX HTTP BUBBLE GET request and sends it to the system 30′, moving the process back to block 304, where the process continues as detailed above.

However, if the browsing application is not directed to a new target web page, the process moves to block 358. Here, a new GET request is not detected, as a GET request has not been issued by the YZ APP 32′. At block 358, the browser session is terminated and the connection is, at least temporarily, lost. For example, the process moves to block 320 where it ends for this user, for this session.

Attention is now also directed to FIG. 4 where the system 30′ has presented the user with an interactive web document 509, as it appears in FIG. 5B, as a result of the user having previously downloaded the YZ APP 32′ and logged into the system 30′. The login may be through social network connect 62, or through the system 30′, via the registration module 33b, as detailed above.

The process begins at block 402 where an indicator of a right-click 566 by a user on an HTML element 568 is received by the client, for example, the YZ APP 32′, as shown in FIG. 5N. For example, with a right-click 566 (or corresponding tap on the screen of a mobile device) from the user, the system 30′ identifies the HTML element 568 within the interactive web document 560, as also shown in FIG. 5N. The process then moves to block 404, where the system 30′ presents a context menu 570 to the user. Here, the standard browser context menu appears within which “Yeez.it comment” 572 is displayed as a selectable option, as the YZ APP 32′ is running on the user's browsing application.

The process moves to block 406, where the system 30′ receives data from the activated element 572 of the context menu 570, as shown in FIG. 5. Here, for example, the system 30′ receives confirmation that the user clicked 574 on the menu option “Yeez.it comment” 572 (associated with the YZ APP 32′) from within the selectable options of the browser context menu 570 as shown in FIG. 5.

In response to receiving data from the activated element 572 of the context menu 570, the system 30′ executes the CSS selector function of the client, e.g., the YZ APP 32′, and identifies the HTML element, which was clicked on, by a right click, by the user, at block 408. The CSS Selector function of the YZ APP 32′ identifies the closest HTML element to the click, or tap, 566 (FIG. 5N) and presents the user with a comment box 576, which creates a web input and interactive document 580, as is shown on FIG. 5P. The YZ APP 32′, using the CSS selector function, then creates a comment box 576 around the HTML element 581, and presents the user with a web input and interactive document 580 at block 410.

The process moves to block 412, where it is determined if the system 30′ has detected a timeout. If a timeout is detected, the process moves to block 320, where it ends.

If a timeout is not detected, the process moves to block 414, where it is determined if a click by the user, outside of the comment box 576, is detected. If the user has clicked outside the comment box 576 (FIG. 5P), the process returns to block 402, where the process continues, as detailed above.

However, if a click outside of the comment box 576 (FIG. 5P) is not detected at block 414, the process moves to block 416 where the user inputs text 582 and submits it to the system 30′ by clicking on the SUBMIT button 584 as shown in FIG. 5Q. Clicking on the SUBMIT button 584 creates an AJAX HTTP COMMENT POST request which is received by the system 30′ and the process moves to block 418.

At block 418, the web framework 33 takes the data generated by the user (e.g., a unique identifier, Bubble_ID, User_ID and comment text) in the HTTP POST request and writes it to the COMMENT table 36c of the database 34 by creating a new row in the COMMENT table 36c. Once the data is transferred to the database 34, the process moves to block 420 where the user is presented with an activatable and interactive web document 586 containing at least one comment icon 516 appearing next to the HTML element 568, that was clicked on, at block 402, as shown in FIG. 5R. From block 420, the process moves to block 354, where it resumes as detailed above.

While the method and system shown and described above include a single instance of a comment icon (which is a precursor of a comment box), multiple comment icons for generating comment boxes are also permissible to overlie the web page in the same manner as above. Such multiple comment boxes 590 may be placed over a single web page, such as in activatable and interactive web document 592, at user-selected locations in accordance with the preset layout of the content on the web page, as shown in FIG. 5S.

In alternative embodiments, the system 30′ may be programmed to aggregate and map comments made across specific web sites and web pages. As a result, site or system administrators can track popular content, controversial content or actors, and successful or problematic advertising, information providing and/or marketing campaigns. Additionally, the system 30′ can be programmed to follow each comment made, such that it is tagged, so as to be stored as a comment string, in a subdatabase of the database 34, so as to track trends, memes, language development, mass opinions and phrase coinage while providing a tool for the public to monitor participation in public conversations. These comment strings can also be broken down further so as to allow for cross referencing with metadata which can be used to generate content links, to connect like-minded commenters, and or to make forecasts regarding the quality of comments on current and/or future web documents associated with the system 30′.

Also, comments such as those of the same or similar subject matter, the same author, or other parameter, from the same or different web documents, associated with the same or different web pages or web sites, can be stored in subdatabases of the database 34. The aforementioned subdatabases may be searchable by users, including those who have not downloaded the YZ APP 32, by the user accessing the home server 30 at www.homeserver.com, or through an available search engine, such as Google®, Yahoo® and the like. These sub databases are to provide end users with information associated with web sites, web pages, web content, prominent authors, as well as other specific data that can be accessed over the network 15 and associated with the system 30′. Users of the system 30′ and/or entities (including other users) with access to the system 30′ will be able to perform wide data mining operations based on inputs from commenters, publishers and third party rating agencies or actors.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for posting displayable media on web pages over a network, comprising:
receiving a request from a first user to render an electronic document over at least a portion of a target web page to which the browsing application of a computer of the first user is directed;
automatically responding to the received request including rendering an electronic document to the target web page over a network;
receiving displayable media input from the first user whose browsing application is directed to the target web page, the computer of the first user being associated with the electronic document; and,
placing the displayable media input into the electronic document, the electronic document with the displayable media for overlying at least a portion of the target web page.

2. The method of claim 1, wherein the displayable media includes text defining a comment.

3. The method of claim 1, additionally comprising:
rendering the electronic document including the displayable media in a viewable format to the browsing application of a computer of a second user over the target web page, when the browsing application of the computer of the second user is directed to the target web page and the computer of the second user is associated with the electronic document.

4. The method of claim 1, wherein the electronic document is independent of the target web page.

5. A system for facilitating the posting of displayable media on web pages over a network, comprising:
a processor; and,
a storage media in communication with the processor for storing instructions executable by the processor, the instructions comprising:
receiving a request from a user to render an electronic document over at least a portion of a target web page to which the browsing application of a computer of the first user is directed;
automatically responding to the received request including rendering an electronic document to the target web page over a network;
receiving displayable media input from the user whose browsing application is directed to the target web page, the computer of the user being associated with the electronic document; and,
placing the displayable media input into the electronic document, the electronic document with the displayable media for overlying the target web page.

6. The system of claim 5, wherein the electronic document is independent of the target web page.

7. The system of claim 6, wherein the electronic document is configured to overlie at least a portion of the target web page.

8. A computer usable non-transitory storage medium having a computer program embodied thereon for causing a suitably programmed system to facilitate the posting of displayable media on web pages over a network, by performing the following steps when such program is executed on the system, the steps comprising:
receiving a request from a first user to render an electronic document over at least a portion of a target web page to which the browsing application of a computer of the first user is directed;
automatically responding to the received request including rendering an electronic document to the target web page over a network;
receiving displayable media input from the first user whose browsing application is directed to the target web page, the computer of the first user being associated with the electronic document; and,
placing the displayable media input into the electronic document, the electronic document with the displayable media for overlying at least a portion of the target web page.

9. The computer usable non-transitory storage medium of claim 8, wherein the displayable media includes text defining a comment.

10. The computer usable non-transitory storage medium claim 8, additionally comprising the step of:
rendering the electronic document including the displayable media in a viewable format to the browsing application of a computer of a second user over the target web page, when the browsing application of the computer of the second user is directed to the target web page and the computer of the second user is associated with the electronic document.

11. The computer usable non-transitory storage medium of claim 8, wherein the electronic document is independent of the target web page.
